(19) United States
(12) Patent Application Publication
(10) Pub. No.: US 2025/0122086 A1
(43) Pub. Date: Apr. 17, 2025

(54) METHOD FOR LITHIUM SORPTION EXTRACTION FROM LITHIUM-CONTAINING BRINES

(71) Applicant: JOINT STOCK COMPANY "AXION – RARE AND NOBLE METALS", Solnechnogorsk (RU)

(72) Inventors: Dmitrii Alekseevich KONDRUTSKII, Krasnogorsk (RU); Gadzhi Rabadanovich GADZHIEV, Solnechnogorsk (RU)

(73) Assignee: JOINT STOCK COMPANY "AXION – RARE AND NOBLE METALS", Solnechnogorsk (RU)

(21) Appl. No.: 18/683,788

(22) PCT Filed: Aug. 10, 2022
(86) PCT No.: PCT/RU2022/050247

§ 371 Date: Feb. 15, 2024

(30) Foreign Application Priority Data
Aug. 15, 2021 (RU) 2021124174

(51) Int. Cl. C01D 15/04; B01J 20/06; B01J 20/34; C01D 3/06; C02F 1/28; C02F 101/10

(52) U.S. Cl. CPC C01D 15/04; B01J 20/06; B01J 20/3433; B01J 20/3475; C01D 3/06; C02F 1/281; C02F 2101/10; C02F 2303/16

(57) ABSTRACT

A method of lithium sorption recovery from natural brines and wastewaters. The method comprises introducing a feed lithium-containing brine to a sorption-desorption concentrating module in a form of a vertically mounted column filled with an inorganic granulated sorbent, being a chlorine-containing lithium aluminum double hydroxide. After the sorption, residual lithium-containing feedstock is drained from the column, then washing is made at a rate of at least 6 column volumes per hour in the amount of 150-250% of the sorbent volume, in the same direction as of the feed lithium-containing brine flow. Then lithium desorption from the sorbent is performed with desalinated water in the same direction as of the feed lithium-containing brine flow to obtain a lithium enriched solution. The obtained solution containing almost pure lithium chloride concentrate. The method results in reduced lithium losses with the washing solution and increased purity of the target LiCl concentrate.

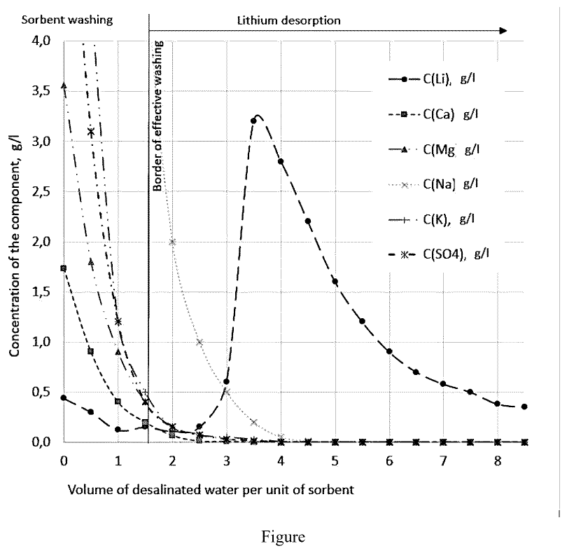

### CROSS REFERENCE TO RELATED APPLICATIONS

This application is a national stage entry of International Application No. PCT/RU2022/050247, filed on Aug. 10, 2022, which is based upon and claims foreign priority to Russian Patent Application No. 2021124174, filed on Aug. 15, 2021, the entire contents of which are incorporated herein by reference.

### TECHNICAL FIELD

The invention relates to the field of lithium hydrometallurgy and can be used to extract lithium from natural brines and waters, process solutions, and wastewaters of various production facilities.

### BACKGROUND

Lithium-containing natural waters and brines is currently one of the types of feedstock used to produce lithium and its compounds. Since the concentrations of lithium ions in such feedstock are low in contrast to the significant concentrations of alkali and alkaline-earth ions and other associated components, applying a sorption technology with the use of sorbents selective to lithium is advantageous to recover lithium from the brines (see, for example, Ryabtsev A.D., Processing of lithium-bearing poly-component hydromineral feedstock based on its lithium concentration, abstract of a Ph.D. thesis for a degree in engineering science, Tomsk, 2011).

To recover lithium from the hydromineral feedstock, lithium aluminum double hydroxide chlorides are known to be used as selective inorganic absorbents. Efficient lithium absorption from the brines using the above absorbents and further lithium desorption to obtain the concentrate is confirmed in various information sources (see, for example, WO 2019221932, Nov. 21, 2019, US20190256368, Aug. 22, 2019, CN 106140121, Nov. 23, 2016, RU 2659968, Jul. 4, 2018, RU 2720420, Jul. 29, 2020, RU 2713360, Feb. 4, 2020, etc.).

However, to obtain a high purity Li-concentrate, for example, suitable for the production of lithium batteries, the above methods require additional treatment stages, extra reagents, and/or use of additional equipment, which complicates the process.

The closest method to the proposed technical solution is a method to process feedstock including sorption lithium extraction from the brines followed by lithium desorption with water.

The method according to RU2688593 selected by the authors as a prototype includes feeding a lithium-containing brine into a vertically installed column filled with granulated inorganic sorbent being a chlorine-containing lithium aluminum double hydroxide, up to lithium saturation in the sorbent, then lithium desorption by feeding desalinated water into the column in the amount of 90-130% of the sorbent volume in the reverse direction to the feed lithium-containing brine to obtain a primary lithium concentrate (lithium chloride solution) with impurities of magnesium and calcium, then purification of the lithium concentrate from the impurities, and after washing recirculation of the brine to the feed lithium-containing brine flow entering the column for sorption.

A disadvantage of the method is a loss of up to 30% of adsorbed lithium at the stage of washing the lithium-saturated sorbent with the demineralized water without brine drain, the lost lithium is transferred to the aqueous washing solution when the salt concentration is lowered. These circumstances require recirculation of lithium and cause reduced sorbent capacity.

### SUMMARY

The object of the present invention is to provide for an efficient method for processing a lithium-containing brine, the method allowing to decrease the volume of recirculated lithium with the washing solution, to increase the purity of the lithium concentrate, and to reduce the number of process stages with possible further processing of the obtained eluate (the strippant) into commercial lithium-containing products.

This object is solved by the described method of lithium sorption extraction of from lithium-containing brines, the method comprising:
introducing a feed lithium-containing brine to a sorption-desorption concentrating module for obtaining a lithium saturated sorbent, wherein the sorption-desorption concentrating module is at least one vertically mounted column filled by inorganic granulated sorbent, wherein the inorganic granulated sorbent is a chlorine-containing lithium aluminum double hydroxide,
draining of residual lithium-containing feedstock from the column before washing, fast washing the lithium saturated sorbent from brine residues with desalinated water at a rate of at least 6 column volumes per hour in the amount of 150-250% of the sorbent volume present in the column, in the same direction as the direction of the feed lithium-containing brine flow,
desorption of lithium from the sorbent with desalinated water in the same direction as the direction of the feed lithium-containing brine flow, to obtain a lithium enriched solution.

In one embodiment, the method further comprising:
recirculating the solution obtained from the stage of washing the saturated sorbent in the column by directing the solution to the feed lithium-containing brine flow.

In yet another embodiment, the method further comprising:
evaporating or concentrating in any other way the lithium enriched solution obtained from the desorption stage and containing almost pure lithium chloride.

The present inventors believe that the technical result is achieved by the above combination of inventive features due to the following reasons. The present inventors have surprisingly found that draining of residual brine from the column with the granulated sorbent and washing the lithium saturated sorbent carried out with desalinated water supplied at a rate of at least 6 column volumes per hour in a volume equal to 150-250% of the volume of the sorbent in the column, in the same direction as the direction of supply of the feed lithium-containing brine provides that the residual impurities of alkali and alkaline-earth metals are displaced from the sorbent inter-granular space.

Due to the high washing rate lithium loss with washing solution is reduced. Without limitation to any specific theory, the present inventors believe that upon washing the lithium saturated sorbent with the demineralized water in the prototype method, in the column loaded with the brine, the salt background concentration is gradually reduced and together with the displacement of brine residues from the intergranular space and impurities lithium chloride starts to transfer from the sorbent into the solution, thus increasing washing losses.

In the proposed method by rapid washing with the desalinated water at a rate of at least 6 column volumes per hour it becomes possible to quickly and fully displace the impurities from the intergranular space with minimal losses of lithium, while the desorption of lithium from the sorbent with desalinated water in the same direction as the direction of the feed lithium-containing brine, provides desorbates purified from impurities due to the chromatographic effect, in contrast to desorbates with impurities of alkali and alkaline earth chlorides metals and boron obtained in the prototype.

### BRIEF DESCRIPTION OF THE DRAWINGS

FIGURE shows a dependency between ion concentration in the solution outgoing from the column and the volume of the desalinated water used for fast washing of the sorbent and the volume of the desalinated water used for lithium desorption from the sorbent.

The diagram shown in FIGURE demonstrates that the wash-off curves of alkali and alkaline-earth metals do not cross the lithium desorption curve, which proves that the purity of the lithium concentrate is increased as compared to the prototype method.

FIGURE also proves that the amount of the desalinated water (150-250 vol. % of the sorbent volume needed for fast washing) is significant since this is the range that ensures separation of wash-off curves of impurities and the target component (Li), i.e. purity of the target product (lithium concentrate) is increased and minimum losses of lithium.

### DETAILED DESCRIPTION OF THE EMBODIMENTS

The proposed method can be implemented as follows.

The feed brine solution can be a natural brine (such as an oil field brine, a geothermal brine, salar brine, etc.), process solution or wastewaters from oil production, chemical or chemical-metallurgical production facilities, or a combination thereof. The feed brine is introduced to the sorption-desorption concentrating module comprising a vertical column or a system of columns connected in series under a revolver scheme, the column filled with granulated sorbent based on the chloride-containing type of aluminum-lithium double hydroxide. Lithium sorption from the feed brine is performed in the sorption-desorption module with a fixed sorbent bed by filtering the feed brine in the flow or in portions. When the sorbent in the column is saturated with lithium, filtering of the feed lithium-containing brine through the column is suspended, the residual lithium-containing brines are drained by switching flows through the column under a revolver scheme and washing the granulated sorbent layer from the brine with the desalinated water in the same direction as the direction of the feed lithium-containing brine flow at a rate of at least 6 column volumes per hour. The volume of the washing solution should be from 150% to 250% of the granulated sorbent volume used in the sorption-desorption concentrating module according to the required degree of washing from impurities. The washing solution is directed to the feed lithium-containing brine flow entering to the sorption-desorption concentrating module for processing of the next portion of the feed lithium-containing chloride brine. Then lithium desorption is carried out by passing the desalinated water through the sorption-desorption concentrating module in the flow of in portions in the same direction as the direction of the feed lithium-containing brine flow. The solution resulted from the desorption process is a lithium concentrate in a form of lithium chloride almost free from impurities of alkali and alkaline-earth metals and sulfates.

If it is required to produce a concentrated product, lithium concentrate containing almost pure lithium chloride produced in the dry residue is evaporated or concentrated in any other way.

### EXAMPLE

Feed brine having the following ionic composition, g/l: lithium Li+—0.437; sodium Na+—114.55; potassium K+—9.1; chloride Cl−—196.0; magnesium Mg2+—3.56; calcium Ca2+—1.73; sulfate (SO42−)—6.51, is introduced in the top-down direction through the sorption-desorption concentrating module being a vertical column filled with the granulated sorbent without a binder-aluminum-lithium double hydroxide of the formula LiCl*2.5Al(OH)3 with 50 wt. % of moisture. The sorbent volume in the column is 5L. The sorbent is brought to saturation by monitoring the lithium concentration balance in the brine upstream and downstream of the column. After the lithium sorption stage is finalized, the residual of lithium-containing brine is discharged from the column by gravity, the sorbent in the column is washed from the residual brine with the desalinated water in the downward direction at a rate 6 columns per hour. Then the lithium desorption stage is carried out by flowing desalinated (demineralized) water through the sorbent column in the downward direction. The outgoing strippant is analyzed to determine concentrations of lithium, sodium, potassium, calcium, magnesium, sulfate. The analysis results are shown in FIGURE.

When the desalinated water is passed through the sorption-desorption concentrating module in the amount from 7.5 to 12.5L, which is from 150% to 250% of the used sorbent volume, most of the impurities of calcium (94.7 and 99.6%, respectively), magnesium (92.1 and 98.9%, respectively), sodium (95.6 and 99.1%, respectively), potassium (95.3 and 98.7%, respectively), sulfates (94.7 and 99.1%, respectively) comprised in the sorption-desorption concentrating module are washed off.

According to the graphs shown in FIGURE, it can be concluded that when washing with the desalinated water at a rate of 6 columns per hour the mechanical displacement of impurities with the residuals of the feed brine occurs, with minimal lithium desorption.

As compared to the prototype, the wash-off effect is high for calcium (up to 99.6%, against 98.8% in the prototype), magnesium (up to 98.9%, against 55% in the prototype), sodium (up to 99.1%, against 55% in the prototype), potassium (up to 98.7%) sulfates (up to 99.1%) contaminating lithium eluates, so the proposed purification method allows better wash-off of the sorbent as compared to the prototype.

The washing solution exiting the sorption-desorption concentrating module in the amount of 150-250% is directed to the feed lithium-containing brine flow entering the sorption-desorption concentrating module for processing the next portion of the feed lithium-containing chloride brine.

Directing the washing solution received from the sorbent wash-off into the flow of the next feed lithium-containing brine portion in the sorption-desorption concentrating module facilitates capturing lithium comprised in the washing solution after the sorbent washing at a concentration of 0.211-0.252 g/l by the sorbent, which prevents lithium losses during its recovery from the lithium-containing chloride brine. The volume of recirculated lithium is 3.6-5.2% of the adsorbed amount (7-12% according to the prototype).

Further desorption of the column of the sorption-desorption concentrating module with the demineralized water allows desorbing lithium chloride into the lithium concentrate having a minimal concentration of calcium impurities of 0.01-0.09%, magnesium impurities of 0.04-0.27%, sodium impurities of 0.82-3.83%, potassium impurities of 0.09-0.31%, sulfate impurities of 0.05-0.27%. According to the prototype, the concentration of impurities in the lithium concentrate is 18% for mere calcium and magnesium impurities, which does not allow obtaining pure lithium chloride without further purification.

During the research, the present inventors tested various known sorbents based on chlorine-containing lithium aluminum double hydroxides. The studies showed that the technical result in the scope of the claimed combination of features was achieved with all types of sorbents of this class.

As it is demonstrated herein, the proposed method defined by the combination of features included in the claims provides for the claimed technical result and has the following advantages as compared to the prototype:
increased efficiency of lithium recovery from lithium-containing brines due to reducing the concentration of impurities in the strippant;
reducing lithium losses with the flush waters;
increased effective operating capacity of the sorbent;
eliminating the discharge of acid and alkali solutions and solutions of additional reagents necessary according to the prototype method in the lithium chloride after-treatment to clean from calcium, magnesium, and sodium impurities.

1. A method for lithium sorption extraction from lithium-containing brines, comprising:
introducing a feed lithium-containing brine to a sorption-desorption concentrating module for obtaining a lithium saturated sorbent, wherein the sorption-desorption concentrating module is at least one vertically mounted column filled with an inorganic granulated sorbent, wherein the inorganic granulated sorbent is a chlorine-containing lithium aluminum double hydroxide;
washing the lithium saturated sorbent;
lithium desorption from the sorbent with desalinated water to obtain a lithium enriched solution; and
wherein the lithium saturated sorbent is washed at a rate of at least 6 column volumes per hour in the amount of 150-250% of the sorbent volume present in the column, in the same direction as the direction of the feed lithium-containing brine flow,
wherein lithium desorption from the sorbent is conducted in the same direction as the direction of the feed lithium-containing brine flow.

2. The method according to claim 1, wherein a solution obtained from the stage of washing the lithium saturated sorbent in the column is recirculated by directing to the feed lithium-containing brine flow.

3. The method according to claim 1, wherein prior to the washing stage residual brine is drained from the column.

4. The method according to claim 1, further comprising: evaporating or otherwise concentrating the lithium enriched solution obtained from the desorption stage and containing almost pure lithium chloride.
